(19) United States
(12) Patent Application Publication
(10) Pub. No.: US 2021/0216596 A1
(43) Pub. Date: Jul. 15, 2021

(54) METHOD FOR EXECUTING A SEARCH AGAINST DEGRADED IMAGES

(71) Applicant: Digital Candy, Inc., Washington, DC (US)

(72) Inventor: Michael St. John, Milford, PA (US)

(21) Appl. No.: 17/148,424

(22) Filed: Jan. 13, 2021

Related U.S. Application Data
(60) Provisional application No. 62/960,579, filed on Jan. 13, 2020.

(51) Int. Cl. G06F 16/951; G06N 3/04; G06K 9/62

(52) U.S. Cl. CPC G06F 16/951; G06K 9/6267; G06N 3/04

(57) ABSTRACT

A method by which degraded images are included in an image search result set is depicted. The method employs a convolutional neural net to analyze and compare a base sample image against all publicly hosted images available on the internet. Well-known AI libraries, such as ResNet 50 are used due to their superior exposure to prevalent images found on the internet. The first and fourth layers as derived by the CNN are reserved as the feature set of the image(s), which are then used for classification and prediction of objects of the image(s). These feature are stored in an ANN-Index to facilitate execution of Euclidean distance calculations and cosign similarity to produce similar images based on features.

### CONTINUITY

This application is a non-provisional application of provisional patent application No. 62/960,579, filed on Jan. 13, 2020, and priority is claimed thereto.

### FIELD OF THE PRESENT INVENTION

The present invention relates to the field of digital imagery, and more specifically relates to a method for searching the internet for instances of the usage of images, especially including those images which have degraded quality, either purposefully or incidentally.

### BACKGROUND OF THE PRESENT INVENTION

As the internet continues to increase in breadth and size, it has become more difficult to note when one's intellectual property is displayed online without authorization. Unwarranted parties may opt to display one's likeness, logo, or similarly protected images without consent, and it is impossible to take the appropriate counter measures until one is aware of the infringement.

This is further complicated when a party displays a degraded, altered, partially corrupted, or similar incomplete depiction of the image. Presently, image search platforms are ill-equipped to detect such degraded images and include them in result sets. However, some forms of machine learning via a convoluted neural net have been crafted for the specific purpose of image analytics. If such methods were trained for the detection of degraded images, image search platforms would be more effective in the detection of such images, authorized or otherwise, on the internet.

Thus, there is a need for a new method by which degraded or otherwise compromised images which are in use online may be matched and identified. Such a method is preferably configured to include all degraded images in the search result set despite any imperfections and altercations to the image file itself, as well as the depiction of the image on the internet.

### SUMMARY OF THE PRESENT INVENTION

The present invention is a method for performing an image search which enables the identification and classification of degraded images as pertinent results in the result set. The method employs machine learning, namely a convolutional neural net. Preferably the ResNet50 model is used as a training base, but any ResNet model may be used. The first and fourth layers of the image are retained and used as the feature set for the search which is preferably executed via well-known AI libraries. The first and fourth layers are employed for the classification and prediction of objects which may not be originally depicted within the image due to the aforementioned degradation.

The following brief and detailed descriptions of the drawings are provided to explain possible embodiments of the present invention but are not provided to limit the scope of the present invention as expressed herein this summary section.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts a flow-chart detailing the steps of the method of the present invention as executed by a computer to facilitate the detection of a degraded image hosted to a publicly accessible domain.

FIG. 2 depicts a direct compare of two images with alliterative green lines showing point to point recognition.

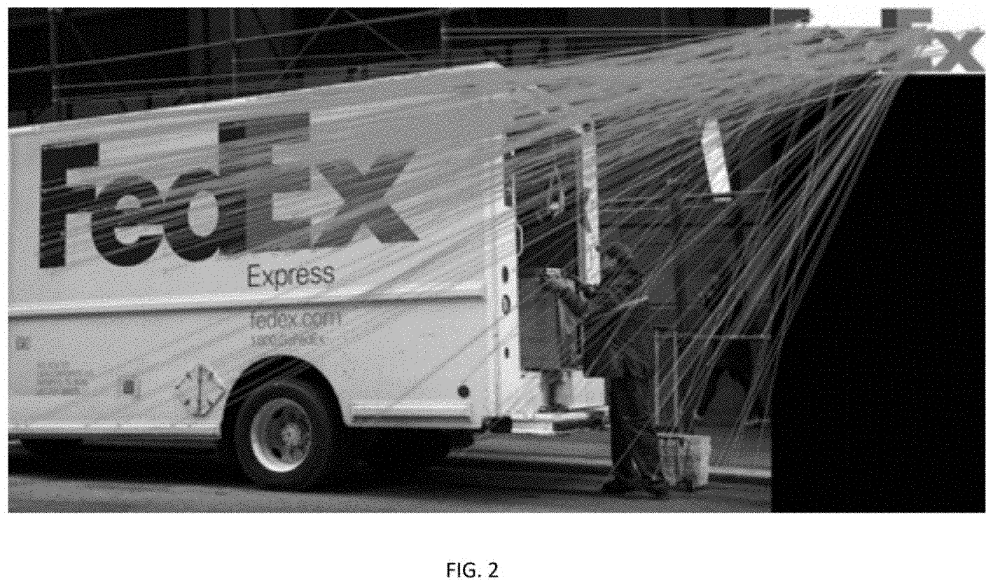

FIG. 3 depicts a compare of two images where the images are not the same with alliterative green lines showing point to point recognition.

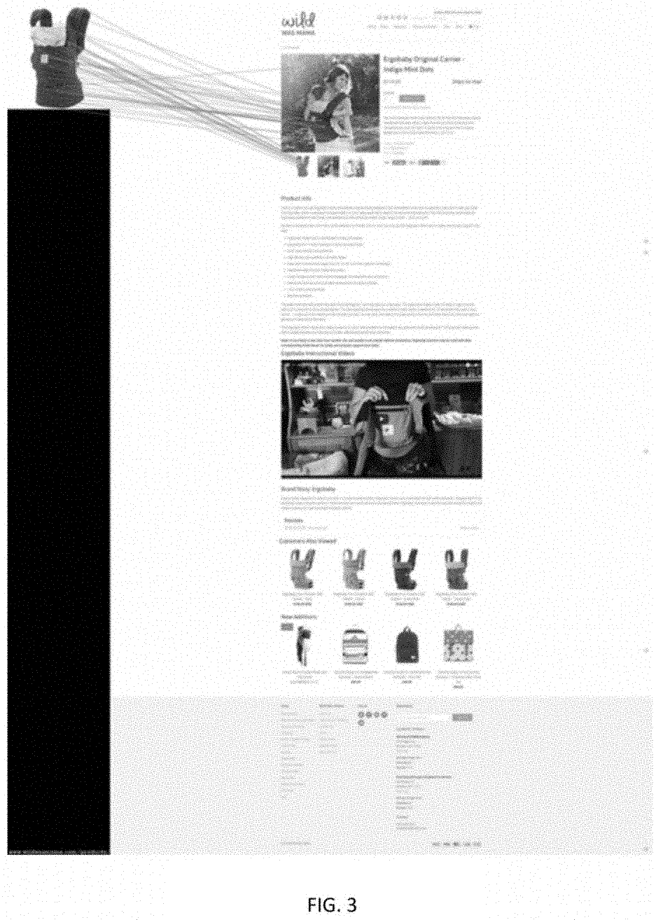

FIG. 4 depicts the use of text recognition inside images.

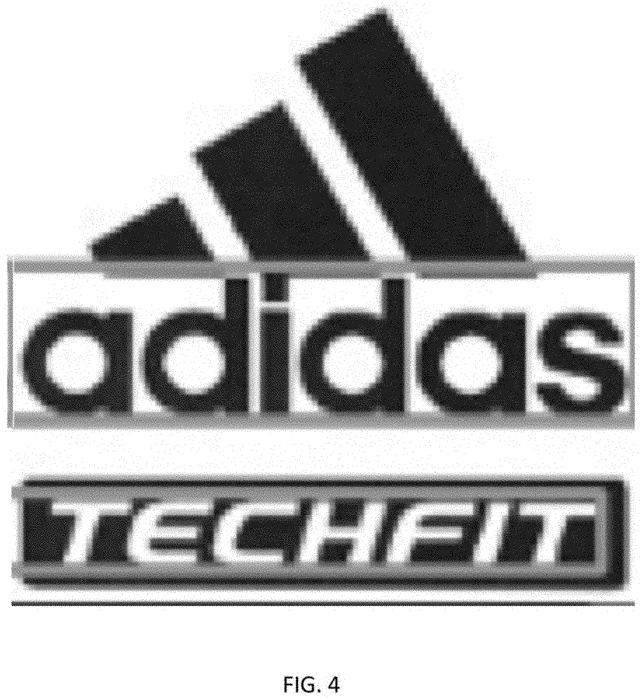

FIG. 5 depicts a flow chart detailing the process of the present invention in executing a similar image search.

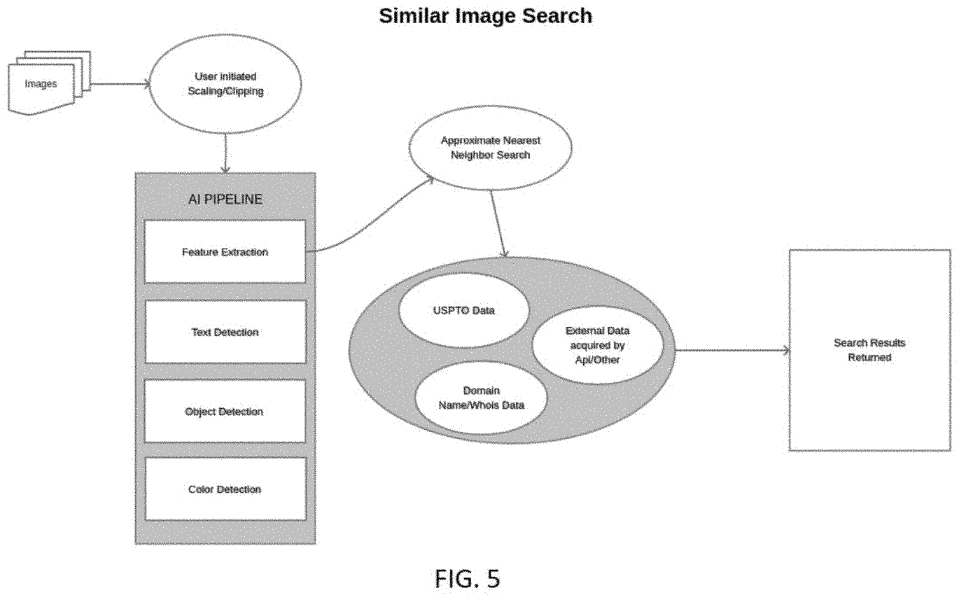

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is a method of performing internet-based image searches which includes degraded, corrupted, or otherwise incomplete images in its result set. The method employs a convolutional neural net (CNN) to analyze digital imagery against a base sample image. The first and fourth layers of the CNN are reserved as the feature set which are used for the classification and prediction of objects of the subject image. The method of the present invention preferably employs ResNet50 (a well-known AI library) as the CNN of choice, as it is known that it has been trained on over one million images sourced from the ImageNet database. It is preferable to use well-known AI libraries as they can provide far better results on degraded images.

The retained feature set, as derived from the first and fourth layers, are stored in an Approximate Nearest Neighbor Index (ANN-Index) to quickly determine distance for predicted objects against the subject image. Similarly, the ANN-Index facilitates the execution of cosign similarity detection. The ANN-Index is preferable as it can execute a K-Nearest Neighbor (KNN) vector search rapidly while achieving efficacious results. Other indexes can be used.

It should be noted that the method of the present invention employs Bert and MultiFiT models to provide text classification and posit a bag-of-words methodology. As MultiFiT is trained on at least 100 documents within the target language, it is optimal for the detection of text components of an image, and for the prediction of any and all degraded text components of the image. Bert is preferably used to cross-check results originating from MultiFiT analysis. For result clustering, the method of the present invention utilizes Lingo3G, a multilingual text clustering engine. With Lingo3G on the text side, and ResNet-50 on the image side, the method of the present invention uses transfer learning to increase the training ability of the system over time.

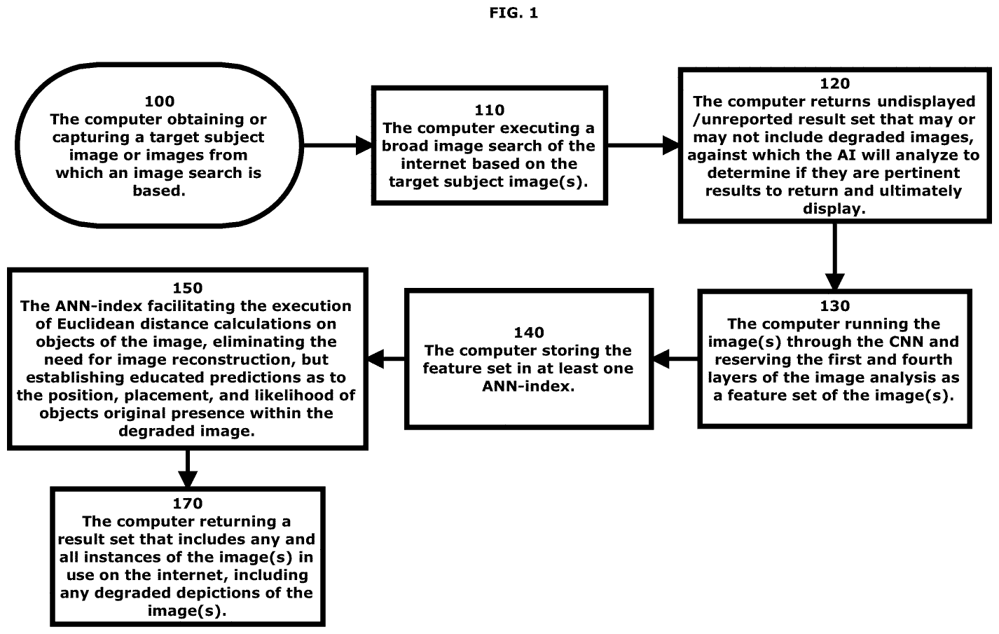

The procedure of use of the method of the present invention, as coordinated and executed by at least one computer as depicted in FIG. 1 is preferably as follows:
1. The computer obtaining or capturing a target subject image or images from which an image search is based. (100) For example, the computer is provided an image via a direct upload, or the computer captures a complete image of a webpage as directed by a user positing a URL.
2. The computer executing a broad image search of the internet based on the target subject image(s). (105)
3. The computer returns undisplayed/unreported result set that may or may not include degraded images, against which the AI will analyze to determine if they are pertinent results to return and ultimately display.
4. The computer running the image(s) through the CNN and reserving the first and fourth layers of the image analysis as a feature set of the image(s). (110)
5. The computer storing the feature set in at least one ANN-index. (120)
6. The ANN-index facilitating the execution of Euclidean distance calculations on objects of the image, eliminating the need for image reconstruction, but establishing educated predictions as to the position, placement, and likelihood of objects original presence within the degraded image. (130)
7. The ANN-index using cosign singularity detection to further root out any and all incongruities within the degraded image. (140) This produces similar images based on features as depicted in the feature set.
8. The computer returning a result set that includes any and all instances of the image(s) in use on the internet, including any degraded depictions of the image(s). (150)

### ADDITIONAL AND ALTERNATIVE EMBODIMENTS

As a further reporting function, once the images have been found within the trademark database, the goods and services associated with the particular marks where the images have been found are then cross referenced and a report allowing the user to see those goods and services which do and which do not have a reference to the image searched is made available. A further reporting capability of cross referencing any of the data in the trademarks found to the images is also available.

As a further embodiment, first on the training side, the features of the image are first extracted and then the above mentioned training is completed, after which, using a known algorithm “EAST” because it's an: Efficient and Accurate Scene Text detection pipeline we extract the bounding box of where the text is from the algorithm and then use optical character recognition (OCR) to convert the content of the bounding box to text. We then apply the text to the classification records for the image. Later during the search we use the extracted text as a secondary classification.

It should be noted that the above method allows the search tool to either continue to search the full set based on the images or to create a subset based solely on the words found within the images making the search faster and more efficient.

All of the above methods may be used for video over the iteration of what is well known as the key frames (the starting and ending points of the smooth transition).

The systems Tech stack includes: Solr 8.X (SolrCloud Configuration with Distributed Zookeepers), Dropwizard 3.X, Vertx 3.x, Postgresql 11.x, Hazelcast Distributed Memory Grid and Flask (Ai Model Serving). The system, although it is running on Amazon AWS servers, is not specifically tied to AWS or its infrastructure. However, being on cloud server systems allows for endless scalability.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A method for executing an image search against any and all images hosted to the internet comprising:
a computer capturing at least one target subject image for the basis of the image search;
the computer executing a broad image search of the internet based on the at least one target subject image;
the computer returning a first result set that contains degraded images, against which an artificial intelligence of the computer is equipped to analyze to determine if the degraded images are pertinent results to ultimately display as a final output;
the computer returning a second result set that contains non-degraded images, against which an artificial intelligence of the computer is equipped to analyze to determine if the non-degraded images are pertinent results to ultimately display as a final output;
the computer running the first result set and second result set through a Convolutional Neural Net (CNN) and preserving the first and fourth layers of the resulting image analysis of the CNN as a feature set of the at least one target image;
the computer storing the feature set in at least one Approximate Nearest Neighbor (ANN) index;
the ANN-index facilitating the execution of Euclidean distance calculations on objects of the image to eliminate the need for image reconstruction and establish informed predictions as to the position, placement, and likelihood of objects' original presence within the degraded image;
the ANN-index using cosign singularity detection to further locate all incongruities within the degraded image, producing similar images based on the features as depicted in the feature set; and
the computer returning and displaying a final result set which includes all instances of the at least one image in use on the internet, including any degraded depictions of the at least one image.

2. The method of claim 1, further comprising:
the computer storing the final result set and associated feature set of the at least one image in a database.

3. The method of claim 1, wherein the artificial intelligence is associated with the CNN; and
wherein the preferred CNN used is ResNet50.

4. The method of claim 1, wherein Bert and MultiFiT models are used to provide text classification and posit a bag-of-words methodology to facilitate the detection of text components of the at least one image.

5. The method of claim 1, further comprising:
the computer using transfer learning to increase the training ability to search for images over time.

6. The method of claim 1, wherein the at least one image are key frames of a video.

7. The method of claim 1, wherein the computer is outfitted with a tech stack which includes at least the following services: Solr, Dropwizard, Vertx, Postgresql, Hazelcast Distributed Memory Grid, and Flask AI Model Serving.

8. The method of claim 1, wherein the computer is a cloud-based server system.

9. The method of claim 2, wherein the artificial intelligence is associated with the CNN; and
wherein the preferred CNN used is ResNet50.

10. The method of claim 2, wherein Bert and MultiFiT models are used to provide text classification and posit a bag-of-words methodology to facilitate the detection of text components of the at least one image.

11. The method of claim 4, the computer using transfer learning to increase the training ability to search for images over time.

12. The method of claim 5, wherein Bert and MultiFiT models are used to provide text classification and posit a bag-of-words methodology to facilitate the detection of text components of the at least one image.

13. A method for executing an image search against any and all images hosted to the internet comprising:
a computer capturing at least one target subject image for the basis of the image search;
the computer executing a broad image search of the internet based on the at least one target subject image;
the computer returning a first result set that contains degraded images, against which an artificial intelligence of the computer is equipped to analyze to determine if the degraded images are pertinent results to ultimately display as a final output;
the computer returning a second result set that contains non-degraded images, against which an artificial intelligence of the computer is equipped to analyze to determine if the non-degraded images are pertinent results to ultimately display as a final output;
the computer running the first result set and second result set through a Convolutional Neural Net (CNN) and preserving the first and fourth layers of the resulting image analysis of the CNN as a feature set of the at least one target image;
wherein the artificial intelligence is associated with the CNN;
wherein the preferred CNN used is ResNet50;
the computer storing the feature set in at least one Approximate Nearest Neighbor (ANN) index;
the ANN-index facilitating the execution of Euclidean distance calculations on objects of the image to eliminate the need for image reconstruction and establish informed predictions as to the position, placement, and likelihood of objects' original presence within the degraded image;
wherein Bert and MultiFiT models are used to provide text classification and posit a bag-of-words methodology to facilitate the detection of text components of the at least one image;
the ANN-index using cosign singularity detection to further locate all incongruities within the degraded image, producing similar images based on the features as depicted in the feature set;
the computer returning and displaying a final result set which includes all instances of the at least one image in use on the internet, including any degraded depictions of the at least one image;
the computer storing the final result set and associated feature set of the at least one image in a database; and
the computer using transfer learning to increase the training ability to search for images over time.

14. The method of claim 13, wherein the at least one image are key frames of a video.

15. The method of claim 13, wherein the computer is outfitted with a tech stack which includes at least the following services: Solr, Dropwizard, Vertx, Postgresql, Hazelcast Distributed Memory Grid, and Flask AI Model Serving.

16. The method of claim 13, wherein the computer is a cloud-based server system.
